(19) United States
(12) Patent Application Publication
(10) Pub. No.: US 2021/0326744 A1
(43) Pub. Date: Oct. 21, 2021

(54) SECURITY ALERT-INCIDENT GROUPING BASED ON INVESTIGATION HISTORY

(71) Applicant: Microsoft Technology Licensing, LLC, Redmond, WA (US)

(72) Inventors: Moshe ISRAEL, Ramat-Gan (IL); Yaakov GARYANI, Raanana (IL); Roy LEVIN, Haifa (IL)

(21) Appl. No.: 16/851,195

(22) Filed: Apr. 17, 2020

(51) Int. Cl. G06N 20/00; G06N 5/02

(52) U.S. Cl. CPC G06N 20/00; G06N 5/02

(57) ABSTRACT

Technology automatically groups security alerts into incidents using data about earlier groupings. A machine learning model is trained with select data about past alert-incident grouping actions. The trained model prioritizes new alerts and aids alert investigation by rapidly and accurately grouping alerts with incidents. The groupings are provided directly to an analyst or fed into a security information and event management tool. Training data may include entity identifiers, alert identifiers, incident identifiers, action indicators, action times, and optionally incident classifications. Investigative options presented to an analyst but not exercised may serve as training data. Incident updates produced by the trained model may add an alert to an incident, remove an alert, merge two incidents, divide an incident, or create an incident. Personalized incident updates may be based on a particular analyst's historic manual investigation actions. Grouped alerts may be standard, or be based on custom alert triggering rules.

### BACKGROUND

Attacks on computing systems take many different forms, including some forms which are difficult to predict, and forms which may vary significantly from one situation to another. But a wide variety of hardware and software tools may be available in a given situation to improve cybersecurity. Detection tools may detect anomalies, rule violations, unexpected behaviors, and other events or conditions that can be investigated by a security analyst. Many devices and some tailored tools provide forensic data, such as by maintaining logs that help track events of potential or likely interest. Some tools aid the investigation of events in a computing system, by consolidating events from multiple sources, correlating events based on timecodes, and providing computational functionality to sort or filter events. Some tools help analysts or other security personnel with incident handling, which may include investigation efforts as well as steps that try to limit the scope of an attack and reduce or repair the damage caused by the attack.

However, attackers continue to create new kinds of attacks and to improve the effectiveness of known attack categories. Accordingly, technical advances that extend or leverage the functionality of existing cybersecurity tools and techniques would also be helpful.

### SUMMARY

An understanding of how security alerts relate to one another, or do not relate, can greatly facilitate investigations of possible cyberattacks. Some of the embodiments described in this document provide improved technology for automatically grouping security alerts into incidents by leveraging data about earlier groupings. A machine learning model is trained using carefully selected training data about past alert-incident grouping actions. Then new alerts are fed to the model, which prioritizes them by grouping them with existing incidents or into new incidents or leaving them ungrouped. The groupings may be provided directly to an analyst, or they may be fed into a security information and event management tool (SIEM).

Some embodiments use or provide an alert-incident grouping hardware and software combination which includes a digital memory and a processor which is in operable communication with the memory. The processor is configured, e.g., by tailored software, to perform certain steps for machine learning model training. The steps include (a) collecting a set of digital representations of alert-incident grouping actions performed by an analyst, each representation including an entity identifier, an alert identifier, an incident identifier, an action indicator, and an action time, and (b) submitting at least a portion of the set to a machine learning model as training data for training the machine learning model to predict an alert-incident grouping action which is not in the submitted portion of the set.

Some embodiments use or provide steps for training a machine learning model to predictively group cybersecurity alerts with cybersecurity incidents based on historic grouping actions. The steps may include collecting a set of digital representations of alert-incident grouping actions, and submitting at least a portion of the set to a machine learning model as training data for training the machine learning model to predict an alert-incident grouping action which is not in the submitted portion of the set. Each representation may include an entity identifier, an alert identifier, an incident identifier, an incident classification, an action indicator, and an action time, for example.

Some embodiments use or provide a computer-readable storage medium configured with data and instructions, or use other computing items, which upon execution by a processor cause a computing system to perform an alert-incident grouping method. In particular, some embodiments use a trained machine learning model to predictively group a cybersecurity alert with a cybersecurity incident based on historic grouping actions. The alert-incident grouping method includes getting an alert, sending the alert to a trained machine learning model, and receiving an incident update from the trained model in response to the sending. The model was trained with training data that includes a set of digital representations of alert-incident grouping actions performed by one or more people as opposed to grouping based on a rules data structure, each representation including an entity identifier, an alert identifier, an incident identifier, an incident classification, an action indicator, and an action time. The incident update may include an alert-incident grouping which groups the alert with an incident, an incident merger which identifies an incident which was created by merging two incidents, or an incident division which identifies at least two incidents which were created by dividing an incident, for example.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating computer systems generally and also illustrating configured storage media generally;

FIG. 2 is a block diagram illustrating a computing system equipped with alert-incident grouping functionality, and some aspects of a surrounding context;

FIG. 3 is a block diagram illustrating an enhanced computing system configured with alert-incident grouping functionality;

FIG. 4 is a block diagram illustrating some aspects of alert-incident grouping action digital representations;

FIG. 5 is a block diagram illustrating some examples of entities that may be part of security alerts;

FIG. 6 is a block diagram illustrating some examples of training data sources;

FIG. 7 is a data flow architecture diagram of an example system that is equipped for automated alert-incident grouping;

FIG. 8 is a diagram illustrating an example of a cybersecurity alert investigation graph;

FIG. 9 is a flowchart illustrating steps in some alert-incident grouping model training methods;

FIG. 10 is a flowchart illustrating steps in some alert-incident grouping trained model usage methods; and

FIG. 11 is a flowchart further illustrating steps in some alert-incident grouping model training or trained model usage methods.

### DETAILED DESCRIPTION

Overview

Innovations may expand beyond their origins, but understanding an innovation's origins can help one more fully appreciate the innovation. In the present case, some teachings described herein were motivated by technical challenges faced by Microsoft innovators who were working to improve the usability, efficiency, and effectiveness of Microsoft cybersecurity offerings, including versions of some Azure Sentinel® security information and event management (SIEM) offerings (mark of Microsoft Corporation).

In particular, due to the high volume, diversity, and complexity of the alerts available to a SIEM, a technical challenge was to how to automatically group related alerts to incidents in ways that help security analysts with their investigations. Grouping related alerts to a single incident or a single case correctly may be the difference between a fruitful and a frustrating investigation effort.

As an aside, a distinction may be made in some contexts between incidents and cases in that a case may have multiple incidents. But teachings herein apply beneficially both to grouping alerts into incidents and to grouping alerts into cases, so “alert-incident grouping” applies to both examples of grouping unless stated otherwise. That is, “case” may be substituted for “incident” outside this paragraph unless stated otherwise.

Some investigations generate incidents based on kill chain steps or based on other deterministic rules. Even with guidance from deterministic rules, investigating security alerts may be an exhausting exercise, and the difference between a successful investigation and an unsuccessful one may be in the SIEM's ability to present correlated alerts together with sufficient accuracy.

By contrast, some embodiments described herein provide personalized incident generation based on a customer's historic manual investigation actions. Some embodiments perform automatic incident creation or modification per customer, and per a customer's specific custom data. Some embodiments allow users to create an incident for various kinds of data and alerts, including custom data and custom alerts. An embodiment may learn user actions from previous investigations made by an organization's security analysts, for example, and use that knowledge to group newly arriving alerts to incidents based on the alerts' relationships to the learned prior grouping actions.

Other technical challenges are also addressed by teachings herein. For example, some challenges addressed herein are how to select effective training data, how to extend learning capability beyond investigation to incident handling, which algorithms to use within the machine learning model, and how to integrate model output with an existing cybersecurity infrastructure, among others. One of skill will recognize these and other technical challenges as they are addressed at various points within the present disclosure.

Other aspects of these embodiments, and other alert-incident grouping enhancement embodiments, are also described herein.

Operating Environments

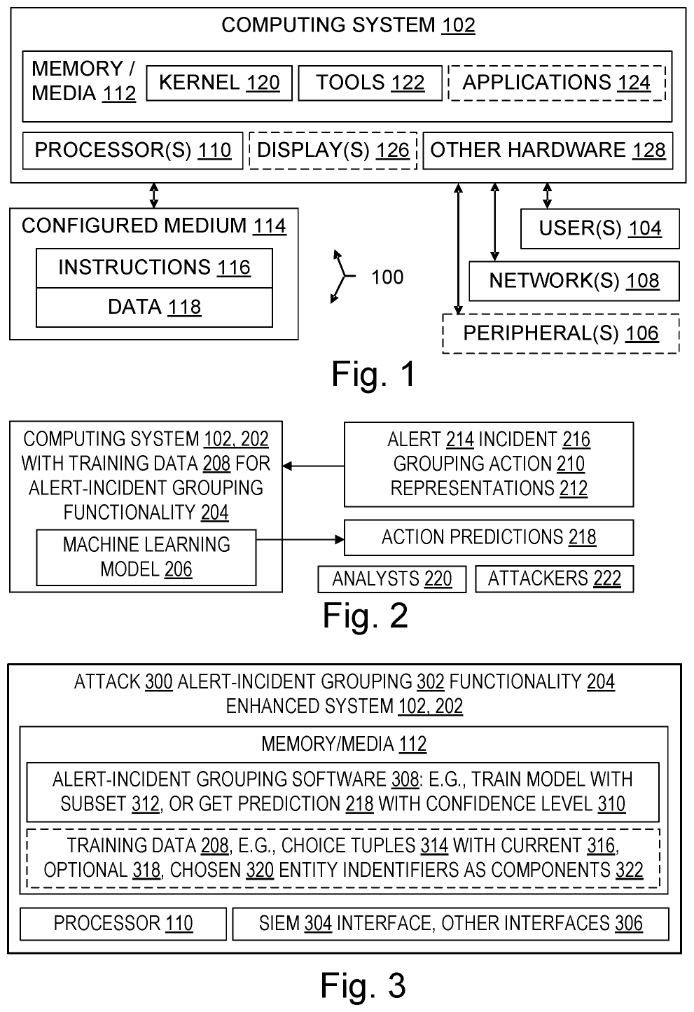

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106, via typed text, touch, voice, movement, computer vision, gestures, and/or other forms of I/O. A screen 126 may be a removable peripheral 106 or may be an integral part of the system 102. A user interface may support interaction between an embodiment and one or more human users. A user interface may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of user 104. Automated agents, scripts, playback software, devices, and the like acting on behalf of one or more people may also be users 104, e.g., to facilitate testing a system 102. Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a network 108 via network interface equipment, for example.

Each computer system 102 includes at least one processor 110. The computer system 102, like other suitable systems, also includes one or more computer-readable storage media 112. Storage media 112 may be of different physical types. The storage media 112 may be volatile memory, non-volatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable non-volatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage medium 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs and/or GPUs), memory/storage media 112, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments peripherals 106 such as human user I/O devices (screen, keyboard, mouse, tablet, microphone, speaker, motion sensor, etc.) will be present in operable communication with one or more processors 110 and memory.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud or enterprise network. In particular, alert-incident grouping functionality could be installed on an air gapped network and then be updated periodically or on occasion using removable media. A given embodiment may also communicate technical data and/or technical instructions through direct memory access, removable nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that items not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

FIG. 2 illustrates an environment having an enhanced system 202, 102 that includes alert-incident grouping functionality 204. In particular, the illustrated system includes a machine learning model 206, which is at least partially trained on training data 208 that includes examples of alert-incident grouping actions 210. The training data 208 includes (or is derived from, or both) digital representations 212 of analyst grouping actions 210, which are actions by a human or automated analyst that created, modified, or deleted a grouping between an alert 214 and an incident 216.

Some examples of training data sources 600 are illustrated in FIG. 6. An instance of one particular source—investigation graphs 602—is illustrated in FIG. 8. This graph includes nodes 800 which are graphical representations of entities 402 together with data 118 representing details 416 such as entity attributes and timestamps. In the FIG. 8 example, some nodes 800, 802 represent anomalies, e.g., a time series anomaly, and other nodes 800, 804 represent devices 102 such as network interfaces which are labeled by their IP address 510. An anomaly may correspond to an alert. In some embodiments, alerts 214 and entities 402 are represented as nodes 800 in investigation graphs 602. For example, if an alert indicates suspicious activity directed to an IP address 1.2.3.4 from a machine X, this will be translated into three nodes in the graph 602: an alert node, an IP address 1.2.3.4 node, and a machine X node. Other graphs 602 may provide different forensic data for alert investigations, or may use different graphical presentations of their forensic data about alerts 214, or may do both.

For convenience, “node” and “entity” may be used interchangeably, with the understanding that a usage of either term may be referring to a graphical representation on a display 126, or to data structure details 416 associated with that graphical representation may be displayed only after the node is expanded, or to both, depending on the context. Similar dual usage of a term does not create ambiguity for one of skill in the art. One of skill may use a single term when referring to a visual representation and/or when referring to the data (not necessarily also visualized) that is associated with the visual representation. For example, “file” may refer to a graphical icon representing a file 504, to the data 118 stored within the file, or to both.

Some alternate embodiments of an enhanced system 202 include a trained model 206 but do not include training data 208. During operation of the trained model functionality 206, a particular alert 214 is fed into the enhanced system 202, and the trained model 206 outputs an action prediction 218 which predicts how an analyst 220 would group (or not group) the particular alert, e.g., during an investigation of activity by a potential attacker 222.

FIG. 3 illustrates an enhanced system 202 which is configured with functionality 204 for performing alert-incident grouping 302 for the investigation or handling of potential or actual cyberattacks 300. Attackers 222 often reside outside a network 108 boundary that is defined, e.g., by firewalls. But teachings herein may also be advantageously applied to perform alert-incident grouping 302 of attacks 300 that are perpetrated by insider attackers 222. Similarly, the system 202 may communicate with a separately located cybersecurity center (not shown), while in other environments an enhanced system 202 resides inside the cybersecurity center, and in still others the enhanced system 202 operates without any cybersecurity center per se.

The system 202 may be networked generally or communicate in particular (via network or otherwise) with a SIEM 304 and other devices through one or more interfaces 306. An interface 306 may include hardware such as network interface cards, software such as network stacks, APIs, or sockets, combination items such as network connections, or a combination thereof.

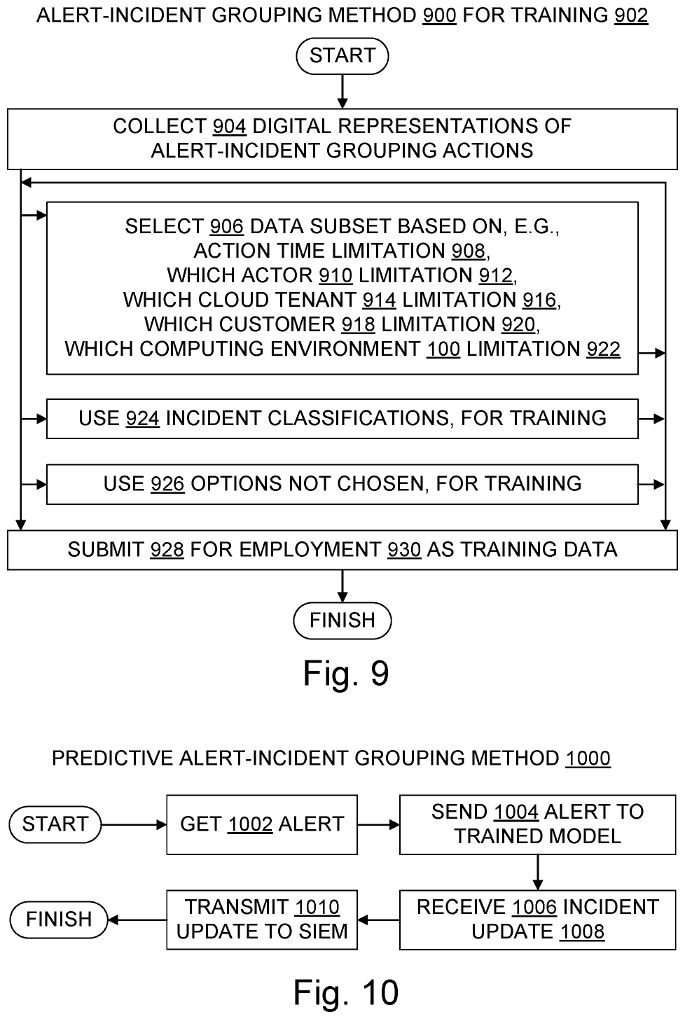

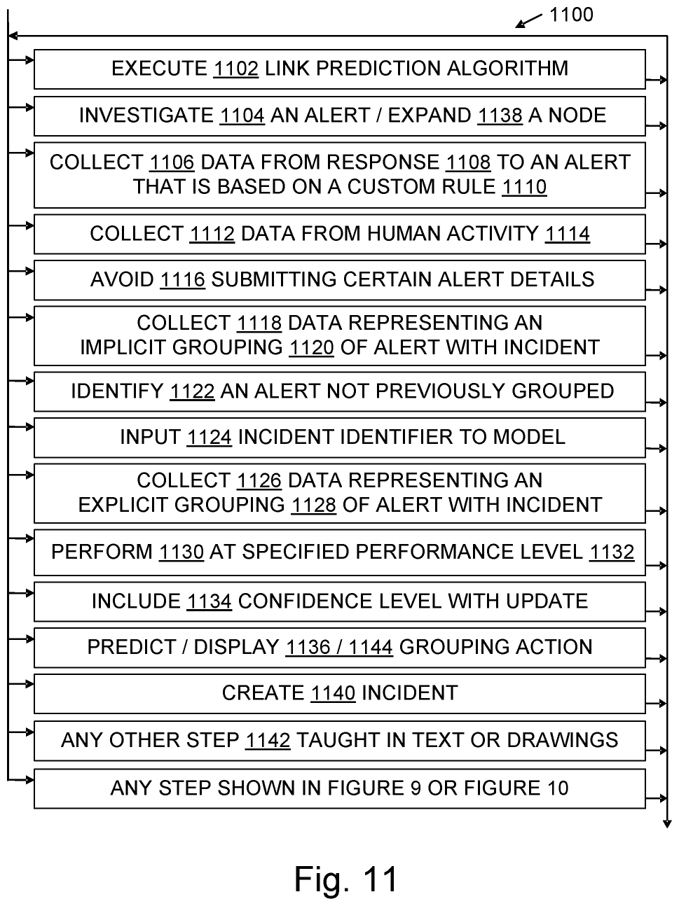

The illustrated system 202 includes alert-incident grouping software 308 to perform computations that may include model 206 training (possibly with specified data subsets 312), model usage to generate predictions 218 (possibly with associated confidence levels 310), or both training and prediction. For example, the software 308 may perform a method 1100 illustrated in one or more of FIGS. 9 through 11.

In some embodiments, the alert-incident grouping model 206 is trained on the basis not only of what an analyst did but also on the basis of what the analyst could have done but chose not to do. Thus, in some embodiments the model training data 208 (whether present on a particular system 202 or not) includes choice tuples 314 that represent choices made by a human analyst 220. The analyst may have been presented in a tool user interface with an alert and with several entities that are possibly relevant to the alert 214. When the analyst took a particular grouping action 210, the entities available for the analyst to expand (a.k.a. “open”, “drill down into”) may accordingly include a currently open entity representation 316 (current entity 316), zero or more entities which were presented to the analyst but were not opened by the analyst as of the time of the particular action 210 (optional entities 318), and zero or more entities presented to the analyst and also opened by the analyst as of the time of the particular action 210 (chosen entities 320). The current entity 316, optional entities 318, and chosen entities 320 are each examples of choice tuple components 322.

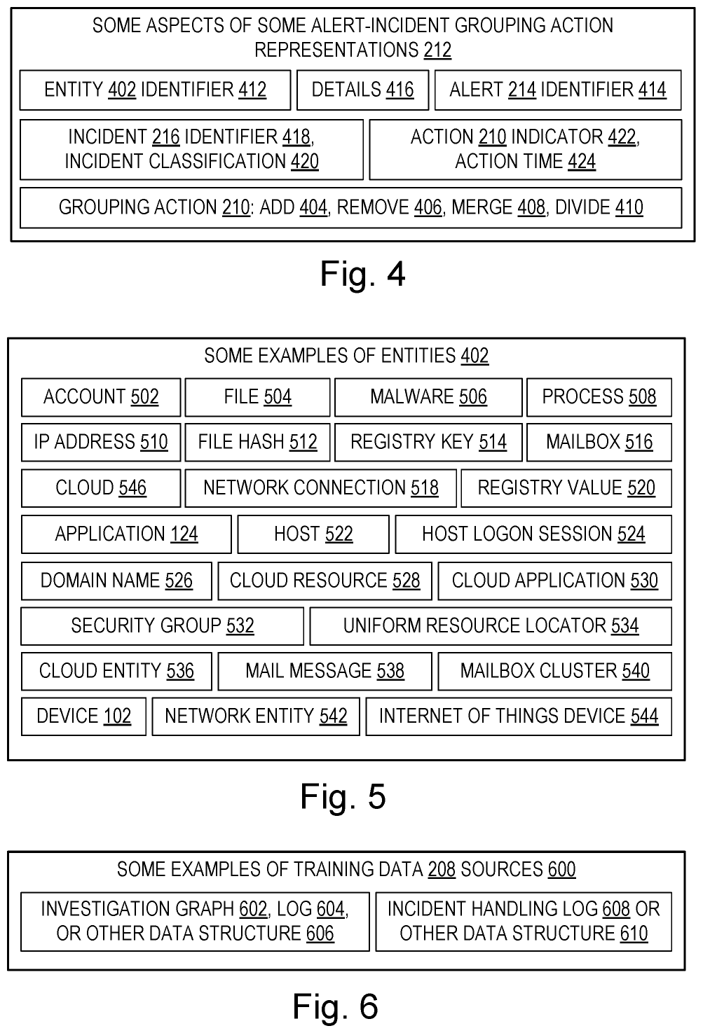

FIG. 4 illustrates several examples of alert-incident grouping action representations 212. These items are discussed at various points herein, and additional details regarding them are provided in the discussion of a List of Reference Numerals later in this disclosure document.

FIG. 5 shows some examples of entities 402 that may be involved in an alert 214. These items are discussed at various points herein, and additional details regarding them are provided in the discussion of a List of Reference Numerals later in this disclosure document.

FIG. 6 shows some examples of sources 600 of training data 208, with the understanding that cleanup, filtering, vectorization, normalization, or other data processing may be applied, e.g., under the supervision of a data scientist, before the training data is submitted for employment in training the model 206. These items are discussed at various points herein, and additional details regarding them are provided in the discussion of a List of Reference Numerals later in this disclosure document.

Some embodiments use or provide a functionality-enhanced system, such as system 202 or another system 102 that is enhanced as taught herein. In some embodiments, a system which is configured for training a machine learning model 206 to predictively group cybersecurity alerts 214 with cybersecurity incidents 216 based on historic grouping actions 210 includes a digital memory 112, and a processor 110 in operable communication with the memory. The processor 110 is configured to perform machine learning model training steps. The steps include (a) collecting a set of digital representations 212 of alert-incident grouping actions 210 performed by an analyst 220, each representation including an entity identifier 412, an alert identifier 414, an incident identifier 418, an action indicator 422, and an action time 424, and (b) submitting at least a portion of the set of digital representations 212 to a machine learning model 206 as training data 208 for training the machine learning model to predict (output a prediction 218 of) an alert-incident grouping action which is not in the submitted portion of the set. In these embodiments, a minimal training data tuple is <entity, alert, incident, action, time of action>.

In some variations, additional tuple components are present in the training data, e.g., incident classification 420, or entities 318 which were available but not opened, or both. Thus, in some embodiments the digital representations 212 of alert-incident grouping actions further include incident classifications 420.

In some embodiments, the entity identifiers 412 in the training data 0identify at least N of the following kinds of entity: account 502, malware 506, process 508, file 504, file hash 512, registry key 514, registry value 520, network connection 518, IP address 510, host 522, host logon session 524, application 124, cloud application 530, domain name 526, cloud resource 528, security group 532, uniform resource locator 534, mailbox 516, mailbox cluster 540, mail message 538, network entity 542, cloud entity 536, computing device 102, or Internet of Things device 544. Depending on the embodiment, N may be one, two, three, four, five, six, seven, eight, nine, or a greater value up to and including the total number of entity examples listed in this paragraph.

In some embodiments, the action indicators 422 indicate at least one of the following alert-incident grouping actions 210 were taken by the analyst 220: adding 404 an alert to an incident, removing 406 an alert from an incident, merging 408 at least two incidents into a single incident, or dividing 410 an incident into at least two incidents. Merging 408 and dividing 410 may include renaming or making other changes to an incident identifier or an incident classification. For example, a benign incident A may be reclassified as malicious upon being merged with an incident B that was classified as malicious, thereby forming a malicious incident AB. Similarly, individual incidents created by dividing a malicious incident may still be classified as malicious, or an incident that was divided out may be reclassified as benign, or as a false positive.

Some embodiments train a model 206 using data 208 that represents alert-incident groupings that could have been made by an analyst 220 but were not made. In some, the training data 208 includes a tuple 314 with components 322 that include a current entity 316 identifier 412, an optional entity 318 identifier 412, and a chosen entity 320 identifier 412. In some of these, the optional entity identifier identifies an entity 402 that was presented to the analyst 220 as available for drilling into to check whether the details 416 therein could impact alert-incident grouping, but was not chosen by the analyst.

In some embodiments, the action indicator 422 indicates an action 210 that was performed by an actor 910 at an action time 424. In some, the enhanced system 202 is configured to train the machine learning model 206 using at least one of the following training data subsets 312: a data subset defined at least in part by a limitation 908 on the action time, a data subset defined at least in part by a limitation 912 on which actor performed the action, a data subset defined at least in part by a limitation 916 on which cloud tenant 914 performed or authorized the action, a data subset defined at least in part by a limitation 920 on which customer 918 performed or authorized the action, or a data subset defined at least in part by a limitation 922 on which computing environment 100 the action was performed in (e.g., which department, which subnet, which geographic location, or other environment delimiter).

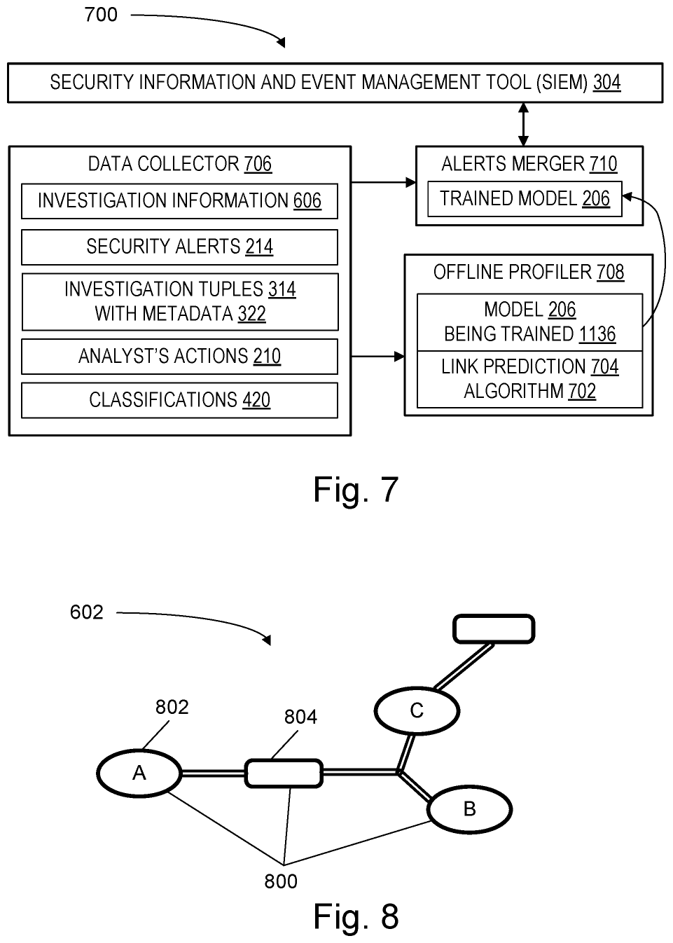

Other system embodiments are also described herein, either directly or derivable as system versions of described processes or configured media, duly informed by the extensive discussion herein of computing hardware. In particular, an example architecture illustrated in FIG. 7 is discussed in detail below after discussion of some process and configured media embodiments.

Although specific architectural examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different technical features, mechanisms, sequences, data structures, or functionalities for instance, and may otherwise depart from the examples provided herein.

Processes (a.k.a. Methods)

FIGS. 9 and 10 each illustrate a family of methods, 900 and 1000 respectively, that may be performed or assisted by an enhanced system, such as system 202 or another functionality 204 enhanced system as taught herein. FIG. 11 further illustrates alert-incident grouping methods (which may also be referred to as “processes” in the legal sense of that word) that are suitable for use during operation of a system which has innovative functionality taught herein. FIG. 11 includes some refinements, supplements, or contextual actions for steps shown in FIG. 9 or 10. FIG. 11 also incorporates all steps shown in FIG. 9 or FIG. 10.

Technical processes shown in the Figures or otherwise disclosed will be performed automatically, e.g., by an enhanced system 202 or software component thereof, unless otherwise indicated. Processes may also be performed in part automatically and in part manually to the extent activity by a human person is implicated, e.g., in some embodiments a human analyst 220 may manually turn on or turn off the logging 604 of grouping actions 210 that are subsequently taken by the analyst, e.g. due to privacy concerns, thereby exercising some control over what data 118 is available for use as training data 208. But no process contemplated as innovative herein is entirely manual.

In a given embodiment zero or more illustrated steps of a process may be repeated, perhaps with different parameters or data to operate on. Steps in an embodiment may also be done in a different order than the top-to-bottom order that is laid out in FIGS. 9-11. Steps may be performed serially, in a partially overlapping manner, or fully in parallel. In particular, the order in which flowchart 900, flowchart 1000, or flowchart 1100 operation items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments use or provide a method for training a machine learning model 206 to predictively group cybersecurity alerts 214 with cybersecurity incidents 216 based on historic grouping actions 210, including the following automatic steps: collecting 904 a set of digital representations 212 of alert-incident grouping actions, each representation including an entity identifier 412, an alert identifier 414, an incident identifier 418, an incident classification 420, an action indicator 422, and an action time 424; and submitting 928 at least a portion of the set to a machine learning model as training data 208 for training 902 the machine learning model to predict 1136 an alert-incident grouping action which is not in the submitted portion of the set. In some variations, incident classification 420 data is not part of the training data 208.

Some embodiments only train 902, some train 902 a model and also use 1136 it, and some only use 1136 the trained machine learning model. In particular, in some embodiments the method further includes using 1136 the trained machine learning model to predictively group an alert with an incident.

Some embodiments apply to training by executing 1102 a link prediction algorithm 702, namely, an algorithm implementation with instructions 116 and data 118 that upon execution performs link prediction 704. One of skill understands that link prediction 704 may be implemented with software according to any one or more of a family of algorithms which are referred to generally as “link prediction algorithms”. Some link prediction algorithms 702 have been applied in scenarios like social networks in which a goal is to recommend a new friendship link between two users, but with the benefit of insight provided by Microsoft innovators such algorithms 702 may be adapted by one of skill consistent with the teachings herein to predictively group 1136 one or more alerts 214 with one or more incidents 216.

In some embodiments, a link prediction algorithm 702 is executed both during a model training 902 phase and then during an evaluation 1136 phase that exercises the trained model. During the training phase, a link prediction model 206 is trained on logs 604 of usage of investigation graphs 602 that contain alert nodes 800. Then, during the evaluation phase the link prediction model 206 can predict 1136 the next related alert, when given a subgraph 606 containing related 302 alerts. In particular, in some embodiments, using 1136 the trained machine learning model includes executing 1102 a link prediction algorithm 702.

In some embodiments, collecting 904 the set of digital representations of alert-incident grouping actions includes collecting data from at least one of the following: an investigation graph 602, an investigation data structure 606, a log 604 of investigative actions taken by at least one human user 104, 220 while investigating an alert, an incident handling data structure 610, or a log 608 of incident-handling actions taken by at least one human user 104, 220 while handling an incident. As an aside, a distinction may be made in some contexts between “incident management”, “incident handling”, and “incident response”. But for the purpose of applying teachings provided herein, these phrases may be treated properly as all meaning the same thing, namely, any tool, information, or procedure designed or used for identifying, understanding, limiting, or remediating a cybersecurity incident.

In some embodiments, training 902 is based on data about the choices made by people, as opposed to grouping 302 based on predefined rules. In particular, in some collecting 904 includes collecting data from a log 604, 608 of human user activity 210 which grouped alerts 214 with incidents 216.

In some embodiments, training 902 is based on data involving alerts generated by custom rules 1110, including for instance rules 1110 that were written by the analyst 220 whose actions 210 are used in the training data 208. This is an example of how an embodiment can be agnostic with regard to the kind of alert 214 involved. In particular, in some embodiments collecting 904 includes collecting 1106 data from activity 210 which responded 1108 to an alert 214 that is based on a custom rule 1110.

In some embodiments, some of the details 416 of an alert may not be used as part of the training data 208. This is another example of how an embodiment can be agnostic with regard to the kind of alert 214 involved. In particular, in some embodiments submitting 928 avoids 1116 submitting any of the following alert details data 416 as training data 208: an alert provider name, an alert vendor name, an alert severity, or an identification of which rule triggered the alert. More generally, any entity attribute values or other entity details 416 that are not specifically included in training data 208 per the teachings herein may be omitted 1116 from training data 208 in a given embodiment.

In some embodiments, training 902 may be based on data which groups alerts with incidents implicitly, or explicitly, or both. Explicit grouping 302 occurs when an analyst provides a command or otherwise takes an action 210 that expressly identifies both an alert and an incident, e.g., an action represented by a description such as “add alert 789 to incident foo”, or “remove alert 456 from incident bar”. Implicit grouping 302 occurs when an analyst provides a command or otherwise takes an action 210 that does not expressly identify both an alert and an incident, e.g., a sequence of actions represented by a description such as “create incident foo; select alerts 12, 34, and 78; add” or by a description such as “merge incidents foo and bar”. Unless “explicit” grouping or “implicit” grouping is recited, the grouping 302 involved with an embodiment may be implicit or explicit or both.

In particular, training may be based on data which groups alerts with incidents implicitly, as when collecting 904 includes collecting 1118 data corresponding to an activity in which an alert 214 was implicitly grouped with an incident 216. Alternatively, in some embodiments, the machine learning model has been trained 902 with training data 208 that includes a set of digital representations 212 of alert-incident grouping actions corresponding to activities in which an alert 214 was explicitly grouped with an incident 216 by a person 220.

As to use of the trained model, some embodiments include inputting 1124 to the trained machine learning model an incident identifier 418 which identifies an incident, and receiving 1006 from the trained model an alert identifier 414 which identifies an alert that was not previously grouped with the incident.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as training data 208, particular training data subsets 312, choice tuples 314, alerts 214, incidents 216, grouping action representations 212, alert-incident grouping software 308, and grouping updates 218, 310, 1008, in the form of data 118 and instructions 116, read from a removable storage medium 114 and/or another source such as a network connection, to form a configured storage medium. The configured storage medium 112 is capable of causing a computer system 102 to perform technical process steps for alert-incident grouping 302, as disclosed herein. The Figures thus help illustrate configured storage media embodiments and process (a.k.a. method) embodiments, as well as system and process embodiments. In particular, any of the process steps illustrated in FIGS. 9-11 or otherwise taught herein, may be used to help configure a storage medium to form a configured storage medium embodiment.

Some embodiments focus on using the trained model (a.k.a. “evaluation phase”), others focus on training the model (“training phase”), and some do both. Method embodiments and storage medium embodiments may focus on training or on evaluation or on training or include both, regardless of whether particular example embodiments under a heading herein only belong to one of these phases.

Some embodiments use or provide a computer-readable storage medium 112, 114 configured with data 118 and instructions 116 which upon execution by at least one processor 110 cause a computing system to perform a method for using a trained machine learning model to predictively group a cybersecurity alert with a cybersecurity incident based on historic grouping actions. This method includes: getting 1002 an alert; sending 1004 the alert to a trained machine learning model 206, the model having been trained 902 with training data 208 that includes a set of digital representations 212 of alert-incident grouping actions 210 performed by one or more people as opposed to grouping based on a rules data structure, each representation including an entity identifier, an alert identifier, an incident identifier, an incident classification, an action indicator, and an action time; and receiving 1006 at least one of the following incident updates 1008 from the trained model in response to the sending: an alert-incident grouping 302 which groups the alert with an incident, an incident merger 408 which identifies an incident which was created by merging two incidents, or an incident division 410 which identifies at least two incidents which were created by dividing an incident. Some embodiments transmit 1010 the incident update 1008 to a security information and event management tool 304.

In some embodiments, the machine learning model has been trained 902 with training data that includes a set of digital representations 212 of alert-incident grouping actions corresponding to activities in which an alert was explicitly grouped 1128 with an incident by a person. In others, training data represents implicit grouping 1120.

Some embodiments are suitable for production use, e.g., in an enterprise, institution, agency, or other professional environment. In some, the enhanced computing system 202 performs 1130 the method at a performance level 1132 of at least twenty-five hundred incident updates per minute. In some, the performance level is at least twenty-five thousand incident updates per minute, and it is contemplated that a performance level 1132 of at least two hundred fifty thousand incident updates per minute is feasible. These performance levels—even the lowest one—may be requirements in a given environment to make security investigation feasible. One of skill will acknowledge that such performance levels—even the lowest one—are not within reach of purely mental activity but instead require an enhanced computing system 202.

In some embodiments, confidence levels 310 are part of the model's output. In particular, in some the incident update 1008 includes a confidence level 310 that is associated with an alert-incident grouping 302 or an incident merger 408 or an incident division 410 which is also part of the incident update 1008.

Additional Examples and Observations

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, some additional examples and observations are offered.

Some embodiments use or provide personalized security alerts grouping based on manual incident management and investigation. Security Information and Event Management (SIEM) systems 304 ingest security alerts and events. Investigating 1104 these alerts may be an exhausting exercise due to the high volume, diversity, and complexity of the alerts. SIEM systems may be expected to collect and group related alerts to cases or incidents to help security analysts 220 with the investigation process. Grouping related alerts to a single case or incident correctly may be the difference between a fruitful and a frustrating investigation effort. However, some approaches generate incidents based only on kill chain steps and other deterministic rules, and so lack flexibility and personalization.

Some embodiments described herein personalize incident generation based on a customer's historical manual investigations. An enhanced system 202 learns user actions from previous investigations made by specified people such as one or more of an organization's security analysts, and uses that knowledge to group newly arriving alerts to incidents based on their relations. An investigation pane (e.g., in a SIEM such as an Azure Sentinel® tool) displays a graph 602 which potentially connects various cloud entities and their related alerts (mark of Microsoft Corporation). Given an investigation starting point, which is typically an alert, the security professional 220 begins the investigation by clicking on relevant nodes in the graph, one at a time, thus opening 1138 up more context 416 which is deemed relevant to the original investigation starting point.

The enhanced system 202 may have an architecture 700 like the one illustrated in FIG. 7. This example architecture 700 includes a Data Collector 706, an Offline Profiler 708, and an Alerts Merger 710. The Offline Profiler 708 includes software which implements an algorithm 702 that performs link prediction 704.

In this example, the Data Collector 706 is responsible for collecting 904 all the relevant data 118 and ingesting a training data 208 portion of it into the enhanced system. The collected data may include one or more investigation graphs 602 that contain information about the nodes 800, 318 the investigator 220 could have opened 1138 but did not (or opened and then promptly closed or otherwise indicated were irrelevant), as opposed to those nodes 800, 320 that the investigator did open 1138 and deem relevant. In some embodiments, the data 208 contains investigation information including security alerts 214 and investigation tuples 314 of the form <current node, optional nodes, clicked node>. For each node 800 the metadata 322, 416 is saved including node type, name, value, and so on. In addition, the Data Collector 706 collects the analyst's actions 210 (e.g., add 404 alert to incident, remove 406 alert from incident, merge 408 incidents) and the classification 420 of the incident, e.g. true, benign or false positive. In some embodiments, the Data Collector 706 can work in different resolutions, for example in one-hour batches, in daily batches, or streaming.

As an aside, opening 1138 a node (expanding it) indicates that the user wanted to have a look at the information not displayed when the node is not open; that information may detail the node or go beyond the node. If the user suspects that the node is part of an attack 300 currently under investigation, the user 220 will expand 1138 the node. Opening 1138 a node does not necessarily indicate a decision 420 was made regarding the incident. That is, actions 210 change incidents 216, whereas opening a node is part of an investigation in which the user is going through the graph 602 and exploring it, but doesn't necessarily take an explicit conclusion 420 or decision 420 regarding the incident.

In this example, the Offline Profiler 708 gets the training data 208 from the Data Collector 706 and uses 902 the data 208 to learn patterns in each customer's investigative behavior by learning their decisions 210 through an investigation path 606, 604. Alerts shared 302 in different successful investigation graphs, over and over again, are more likely to be related to each other.

For example, assume an alert 214 of type “malicious process found” was triggered, pointing to a process P on a machine A. Then a firewall raised an alert 214 of type “suspicious communication” between machine A and machine B. Afterward, an alert of type “malicious process found” was triggered again with process P but now on machine B. The security analyst 220 who investigated the first alert watched the three alerts on the investigation graph and marked 210 them as related to the investigated incident 216 as well as classifying 420 the incident as true positive (malicious). If on other days the same sequence was found again, the Offline Profiler 708 will learn the correlation and will connect these alerts to a single incident in future cases.

This grouping 302 can be accomplished through link prediction 704. Specifically, some embodiments use link prediction to determine which alert would next be added given a current investigation graph which contains only part of the alerts (those seen so far). In some embodiments and some situations, link prediction is executed multiple times, to predict an investigation subgraph or an entire investigation graph, rather than only predicting a next edge (link). Alternatives to link prediction may also be used, e.g., statistical analysis generally, or machine learning algorithms generally, with the understanding that some may view link prediction as an example of statistical analysis or as an example of machine learning, or both.

Once the model 206 is trained and available, the enhanced system 202 may use it to create 1140 or modify 404, 406, 408, 410 incidents 216 when new alerts are raised. In this example, the Alert Merger 710 runs (scheduled or in real-time) and merges alerts to incidents or incidents to one another. This module 710 gets data about security alerts from the Data Collector 706 and runs the trained model on the data of the last N days, with N equal, e.g., a value in the range from 1 to 180. N can be configured or learned by previous incidents' durations. Once an incident is created it is sent 1010 back to the SIEM system.

Some Additional Observations About Entities

As noted, alerts 214 and incidents 216 often involve one or more entities 402. FIG. 5 shows some entity 402 examples. A given implementation may recognize only a few, or most, or all of these example entities 402. Entities 402 may have different attributes, depending on the entity, and those attributes and their values may serve as alert details 416. In some cases, each entity will contain a field called, e.g., “type” which will act as a discriminator, and may contain additional fields per type.

In some embodiments, the structure and format for each entity field is compatible with a model utilized by Microsoft Defender™ Advanced Threat Protection™ (ATP) (marks of Microsoft Corporation). Compatibility may be maintained by also allowing providers to send an enhanced system 202 additional fields.

In some embodiments, entities 402 can be hierarchical or nested and include other types and instances of entities in them. For example, a process entity 508 might include a file entity 504 with information about an executable image file that is used to run the process. When including the file entity inside another entity, the nested entity can be included in-line, e.g., as a nested JSON object or as a reference to another entity.

In some embodiments, each entity can hold additional context that will be added to it during the alert processing stages, e.g., an IP entity 510 might hold geo location. To support the additional context, each entity may contain relevant optional properties that can be complex objects on their own, to hold the attached information. Each context element may be free to be in any schema and may be configured to support backward and forward schema compatibility, by allowing it to contain properties that it is not currently aware of. Contextual data that is added to entities or to the alert may be part of a schema specification document and any code that uses this kind of contextual data may use structures like those defined here, as opposed to a schema-less format.

In some embodiments, each entity may include a set of common optional fields, and there may be unique fields for each type of entity. Common fields for entities may be optional and may be system generated. They may be used when a product is persisting an alert and running analysis on top of alerts and their entities, for example.

One of skill will acknowledge that the attributes for a given entity 402 may vary from embodiment to embodiment, and among implementations of a given embodiment. As one example, however, a process 508 may have attributes such as: process ID, command line used to create the process, time when the process started to run, image file, account running the process, parent process, host, and session. As another example, a file 504 may have attributes such as: full path, file name without path, host, hashes, and threat intelligence contexts. As yet another example, a security group 532 may have attributes such as: group distinguished name, security identifier, and unique identifier for the object representing the group.

The following additional examples are also offered. An URL 534 may have attributes such as: full URL, and threat intelligence contexts. An loT device 544 may have attributes such as: resource 528 entity representing the loT hub the device belongs to, ID of the device in the context of the IoT hub, friendly name of the device, host of the device, ID of the security center for IoT agent running on the device, type of the device (“temperature sensor”, “freezer”, “wind turbine”, etc.), vendor or cloud service provider that is a source of the device, URL reference to the source item where the device is managed, manufacturer of the device, model of the device, operating system the device is running, current IP address of the device, MAC address of the device, list of protocols that the device supports, and serial number of the device.

Based on these examples, and skill in the art, other entity attributes can be similarly defined by one of skill in the art for a particular implementation.

Technical Character

The technical character of embodiments described herein will be apparent to one of ordinary skill in the art, and will also be apparent in several ways to a wide range of attentive readers. Some embodiments address technical activities such as collecting 904 digital training data for machine learning, selecting 906 data subsets, logging 604, 608 cybersecurity forensic activities, training 902 a machine learning model 206, and executing 1102 link prediction algorithms in an enhanced computing system 202, each of which is an activity deeply rooted in computing technology. Some of the technical mechanisms discussed include, e.g., a machine learning model 206, link prediction algorithms 702, training data 208, choice tuples 314, SIEMs 304, interfaces 306, alert-incident grouping software 308, and incident updates 1008. Some of the technical effects discussed include, e.g., automated prediction 1136 of how a human analyst with respond to a new alert 214 in terms of grouping 302 it with existing incidents or creating 1140 a new incident for the alert, personalization of such automated predictions through use of training data subsets 312, automatic alert-incident grouping 302 which builds on implicit or explicit relationships between alerts and incidents, and grouping 302 at production levels 1132 of performance not available through human activity alone. Thus, purely mental processes are clearly excluded. Other advantages based on the technical characteristics of the teachings will also be apparent to one of skill from the description provided.

Some embodiments described herein may be viewed by some people in a broader context. For instance, concepts such as analysis, confidence, decisions, gathering, history, or membership may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to efficiently and effectively predict 1136 how an expert analyst 220 would group a new cybersecurity alert 214 with one or more incidents 216. Other configured storage media, systems, and processes involving analysis, confidence, decisions, gathering, history, or membership are outside the present scope. Accordingly, vagueness, mere abstractness, lack of technical character, and accompanying proof problems are also avoided under a proper understanding of the present disclosure.

Additional Combinations and Variations

Any of these combinations of code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular motivating examples and scenarios, operating system environments, attribute or entity examples, software processes, development tools, identifiers, data structures, data formats, notations, control flows, naming conventions, or other implementation choices described herein.

Any apparent conflict with any other patent disclosure, even from the owner of the present innovations, has no role in interpreting the claims presented in this patent disclosure.

### ACRONYMS, ABBREVIATIONS, NAMES, AND SYMBOLS

Some acronyms, abbreviations, names, and symbols are defined below. Others are defined elsewhere herein, or do not require definition here in order to be understood by one of skill.

ALU: arithmetic and logic unit

API: application program interface

BIOS: basic input/output system

CD: compact disc

CPU: central processing unit

DVD: digital versatile disk or digital video disc

FPGA: field-programmable gate array

FPU: floating point processing unit

GPU: graphical processing unit

GUI: graphical user interface

IaaS or IAAS: infrastructure-as-a-service

ID: identification or identity

IoT: Internet of Things

IP: internet protocol

JSON: JavaScript® Object Notation (mark of Oracle America, Inc.)

LAN: local area network

MAC: media access control

OS: operating system

PaaS or PAAS: platform-as-a-service

RAM: random access memory

ROM: read only memory

SIEM: security information and event management; also refers to tools which provide security information and event management; may also be referred to as SEIM (security event and information management)

TCP: transmission control protocol

TPU: tensor processing unit

UDP: user datagram protocol

UEFI: Unified Extensible Firmware Interface

URI: uniform resource identifier

URL: uniform resource locator

WAN: wide area network

Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

As used herein, a “computer system” (a.k.a. “computing system”) may include, for example, one or more servers, motherboards, processing nodes, laptops, tablets, personal computers (portable or not), personal digital assistants, smartphones, smartwatches, smartbands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both.

“Cloud” means pooled resources for computing, storage, and networking which are elastically available for measured on-demand service. A cloud may be private, public, community, or a hybrid, and cloud services may be offered in the form of infrastructure as a service (laaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write).

“IoT” or “Internet of Things” means any networked collection of addressable embedded computing or data generation or actuator nodes. Such nodes may be examples of computer systems as defined herein, and may include or be referred to as a “smart” device, “endpoint”, “chip”, “label”, or “tag”, for example, and IoT may be referred to as a “cyber-physical system”. IoT nodes and systems typically have at least two of the following characteristics: (a) no local human-readable display; (b) no local keyboard; (c) a primary source of input is sensors that track sources of non-linguistic data to be uploaded from the loT device; (d) no local rotational disk storage—RAM chips or ROM chips provide the only local memory; (e) no CD or DVD drive; (f) embedment in a household appliance or household fixture; (g) embedment in an implanted or wearable medical device; (h) embedment in a vehicle; (i) embedment in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. loT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. loT storage or actuators or data output or control may be a target of unauthorized access, either via a cloud, via another network, or via direct local access attempts.

“Access” to a computational resource includes use of a permission or other capability to read, modify, write, execute, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment. Alert-incident grouping operations such as collecting 904 digital representations 212, selecting 906 data subsets 312 as training data 208, training 902 a machine learning model 206, executing 1102 a link prediction algorithm 702, transmitting incident updates 1008 to a SIEM 304, and many other operations discussed herein, are understood to be inherently digital. A human mind cannot interface directly with a CPU or other processor, or with RAM or other digital storage, to read and write the necessary data to perform the alert-incident grouping steps taught herein. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general purpose processor which executes it, thereby transforming it from a general purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as collecting, creating, executing, getting, grouping, identifying, including, inputting, performing, predicting, receiving, selecting, sending, submitting, training, transmitting, using, (and collects, collected, creates, created, etc.) with regard to a destination or other subject may involve intervening action such as the foregoing or forwarding, copying, uploading, downloading, encoding, decoding, compressing, decompressing, encrypting, decrypting, authenticating, invoking, and so on by some other party, including any action recited in this document, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:

100 operating environment, also referred to as computing environment

102 computer system, also referred to as a “computational system” or “computing system”, and when in a network may be referred to as a “node”

104 users, e.g., an analyst or other user of an enhanced system 202

106 peripherals

108 network generally, including, e.g., clouds, local area networks (LANs), wide area networks (WANs), client-server networks, or networks which have at least one trust domain enforced by a domain controller, and other wired or wireless networks; these network categories may overlap, e.g., a LAN may have a domain controller and also operate as a client-server network

110 processor

112 computer-readable storage medium, e.g., RAM, hard disks

114 removable configured computer-readable storage medium

116 instructions executable with processor; may be on removable storage media or in other memory (volatile or non-volatile or both)

118 data

120 kernel(s), e.g., operating system(s), BIOS, UEFI, device drivers

122 tools, e.g., anti-virus software, firewalls, packet sniffer software, intrusion detection systems, intrusion prevention systems, other cybersecurity tools, debuggers, profilers, compilers, interpreters, decompilers, assemblers, disassemblers, source code editors, autocompletion software, simulators, fuzzers, repository access tools, version control tools, optimizers, collaboration tools, other software development tools and tool suites (including, e.g., integrated development environments), hardware development tools and tool suites, diagnostics, enhanced browsers, and so on

124 applications, e.g., word processors, web browsers, spreadsheets, games, email tools, commands

126 display screens, also referred to as “displays”

128 computing hardware not otherwise associated with a reference number 106, 108, 110, 112, 114

202 enhanced computers, e.g., computers 102 (nodes 102) enhanced with alert-incident grouping functionality

204 alert-incident grouping functionality, e.g., functionality which does at least one of the following: prepares training data 208 for use in training a model 206, trains a model 206, retrains a model 206, submits an alert 214 or an incident 216 or an action 210 to a model 206, executes an algorithm as part of operation of a model 206, receives a prediction 218 from a model 206, conforms with the FIG. 11 flowchart or its constituent flowcharts 1000 or 900, or otherwise provides capabilities first taught herein

206 alert-incident grouping machine learning model, e.g., neural network, decision tree, regression model, support vector machine or other instance-based algorithm implementation, Bayesian model, clustering algorithm implementation, deep learning algorithm implementation, or ensemble thereof; a machine learning model 206 may be trained by supervised learning or unsupervised learning, but is trained at least in part based on alert-incident grouping action representations as training data

208 training data for training an alert-incident grouping machine learning model

210 alert-incident grouping action, e.g., an action which adds 404, removes 406, merges 408, or divides 410

212 alert-incident grouping action representation, e.g., a digital data structure which represents an action 210

214 alert, e.g., a packet or signal or other digital data structure which is generated by one or more events and has been designated as having a higher level of urgency or relevance to cybersecurity than events in general

216 incident, e.g., a digital data structure which includes or otherwise identifies one or more alerts 214 and also has one or more security attributes, e.g., attacker identity, attacker goal, attacker activity past or present or expected, attack mechanism, attack impact, potential or actual defense, potential or actual mitigation

218 alert-incident grouping action prediction, e.g., a machine-generated prediction of an alert-incident grouping action that would be taken by a human analyst

220 analyst; unless stated otherwise, refers to a human who is investigating an alert 214 or an incident 216, or handling an incident 216, or is trained or responsible for doing so; may also apply to a group of analysts, e.g., the analysts working for a particular cloud tenant or particular enterprise

222 cyberattacker, e.g., a person or automation who is acting within a network or a system beyond the scope of the authority (if any) granted to them by the owner of the network or system; may be external or an insider; may also be referred to as an “adversary”

300 attack; may also be referred to as a “cyberattack”; refers to unauthorized or malicious activity by an attacker 222

302 alert-incident grouping; may refer to the activity of creating or modifying a grouping (membership or sibling or dependency relationship) between an alert and an incident; may also refer to a result of such activity

304 security information and event management tool (SIEM)

306 interface

308 alert-incident grouping software

310 confidence level included in or associated with a grouping prediction 218; may be an enumeration (e.g., low/medium/high) ora numeric value (e.g., 0.7 on a scale from 0 lowest to 1.0 highest confidence in accuracy)

312 data subset

314 choice tuple digital data structure

316 current entity in a choice tuple; implemented e.g., as an entity identifier

318 optional entity in a choice tuple; implemented e.g., as an entity identifier

320 chosen entity in a choice tuple; implemented e.g., as an entity identifier

322 choice tuple component

402 entity which may be involved in an alert; also refers to an identifier of such an entity or digital data structure representing such an entity

404 add an alert to an incident

406 remove an alert from an incident

408 merge two incidents; the alerts associated with the merge result incident are the union of the alerts associated with the pre-merge incidents

410 divide an incident into multiple incidents; the alerts associated with the pre-divide incident are divided (not necessarily partitioned—copies may be permitted) among the incidents that result from the dividing

412 entity identifier, e.g., name, address, identifying number, unique location, hash of content or hash of identifying portion of content

414 alert identifier, e.g., name, address, identifying number, unique location, hash of content or hash of identifying portion of content

416 details of an alert

418 incident identifier, e.g., name, address, identifying number, unique location, hash of content or hash of identifying portion of content

420 incident classification, e.g., benign (not malicious), false positive (initially appeared malicious but upon investigation determined to be not malicious), true positive (malicious)

422 action indicator, e.g., a user command ora system operation or another data structure which identifies an analyst's action with respect to an alert and an incident, or with respect to one or more incidents

424 action time, e.g., timestamp indicating when an action 210 occurred; may be used when training 902 a model to help the model learn action 210 sequences in addition to learning individual actions, thereby providing a more accurate and useful model 206

502 account, e.g., a user account generally, or an administrative user account

504 file; also refers to blobs, chunks, and other digital storage items

506 malware

508 process, in the computer science sense

510 IP address or set of IP addresses (IPv4 or IPv6 or both)

512 file hash; may also be referred to as a file hashcode or a file signature

514 registry key

516 mailbox; may refer to a user's mailboxes generally or to a particular mailbox such as an inbox, outbox, or junk mail box; may also refer to mail folder(s)

518 network connection

520 registry value

522 host; an example of a system 102

524 host logon session

526 domain name

528 cloud resource, e.g., a compute resource, a storage resource, or a network resource in a cloud

530 cloud application; may run entirely in the cloud or be provided as a software-as-a-service offering from the cloud; an example of an application 124

532 security group; digital data structure controlling access in a computing system; typically defined by an administrator

534 uniform resource locator (URL)

536 cloud entity; any entity which resides in or communicates with a cloud; an example of a network entity

538 mail message; “mail” refers to electronic mail or other electronic digital messaging

540 mailbox cluster

542 network entity; any entity which resides in or communicates with a network 108

544 Internet of Things device

546 cloud; may be a combination of one or more networks

600 source of training data

602 investigation graph; refers to visual presentation in a tool or to data structure upon which visual presentation is based, or both

604 digital log of investigation activity

606 investigation tracking data structures generally; here and elsewhere “data structure” means a digital data structure in a memory 112 susceptible to be read or written or both using a processor 110

608 digital log of incident handling activity

610 incident handling data structures generally

700 example architecture

702 link prediction algorithm

704 link prediction (verb or noun)

706 data collector module

708 offline profiler module

710 alerts merger module

800 investigation graph node (a.k.a. “entity node” or simply “entity” for convenience)

802 anomaly node

804 device or device interface node

900 flowchart; 900 also refers to training methods illustrated by or consistent with the FIG. 9 flowchart

902 train a machine learning model

904 collect digital representations, e.g., through logging, file transfer, network communications, or other computational activity

906 select a data subset, e.g., by sorting, filtering, or other computational activity

908 data selection limitation as to time at which an action occurred, e.g., a particular time or a closed or open-ended range of times

910 actor, e.g., human or computing system, e.g., an analyst 220

912 data selection limitation as to which actor(s) performed an action

914 cloud tenant; an example of an actor 910

916 data selection limitation as to which cloud tenant(s) performed an action

918 customer; an example of an actor 910

920 data selection limitation as to which customer(s) performed an action

922 data selection limitation as to which environment(s) and action was performed in or targeted by

924 select for use or use an incident classification as to determined or likely maliciousness

926 select for use or use optional entity 318 as training 902 data

928 submit data for use as training data 208, e.g., through file transfer, network communications, or other computational activity

930 use data as training data 208

1000 flowchart; 1000 also refers to alert-incident grouping methods illustrated by or consistent with the FIG. 10 flowchart

1002 get an alert, e.g., through file transfer, network communications, or other computational activity

1004 send the alert to a trained model 206, e.g., through file transfer, network communications, or other computational activity

1006 receive an incident update from the trained model 206, e.g., through file transfer, network communications, or other computational activity

1008 incident update digital data structure

1010 transmit the incident update to a SIEM, e.g., through file transfer, network communications, or other computational activity

1100 flowchart; 1100 also refers to alert-incident grouping methods illustrated by or consistent with the FIG. 12 flowchart (which incorporates the steps of FIGS. 9 and 10)

1102 execute a link prediction algorithm using, e.g., a processor 110 and memory 112

1104 investigate an alert; typically done by a human analyst using a computing system

1106 collect digital data from an analyst's response (e.g., investigation 1104 log) to an alert that is based on a custom rule; performed, e.g., through file transfer, network communications, or other computational activity; this is an example of collecting 904

1108 analyst's response (e.g., investigation 1104) to an alert

1110 custom rule, e.g., a rule that is not shipped as part of a commercially available cybersecurity product or service but is instead crafted by a particular user or particular small (e.g., less than 20) set of users

1112 collect digital data from human activity, e.g., as an investigation log 604 or an incident handling log 608

1114 human activity interacting with a computing system

1116 avoid submitting certain data as part of training data 208

1118 collect digital data representing an implicit grouping 1120 of an alert with an incident; may be performed, e.g., through file transfer, network communications, or other computational activity; this is an example of collecting 904

1120 implicit grouping of an alert with an incident

1122 identify an alert which has not yet been grouped with any incidents; such an alert may also be referred to as a “new” alert or a “newly arrived” alert; performed by computational activity

1124 input an incident identifier to a model 206 via computational activity

1126 collect digital data representing an explicit grouping 1128 of an alert with an incident; may be performed, e.g., through file transfer, network communications, or other computational activity; this is an example of collecting 904

1128 explicit grouping of an alert with an incident

1130 perform computational activity at a specified performance level

1132 computational activity performance level

1134 include a confidence level as part of a data structure; here as elsewhere herein “data structure” is used broadly to include data in memory 112 or in transit between computing systems 102

1136 predict a grouping action or an incident creation

1138 expand a graph node to display additional data, and thereby implicitly indicate relevance to an incident

1140 create an incident 216 data structure, e.g., by allocating memory and populating it with incident data, or by populating previously allocated memory with incident data

1142 any step discussed in the present disclosure that has not been assigned some other reference numeral

1144 display an update 1008 or otherwise provide it directly to an analyst by computational activity

Conclusion

In short, the teachings herein provide a variety of alert-incident grouping functionalities 204 which operate in enhanced systems 202. Cybersecurity is enhanced, with particular attention to promptly giving security analysts 220 and their investigative tools 122, 304 accurate updates 1008 about the relationship of new alerts 214 to past or ongoing incidents 216. Technology 202, 204, 1100 automatically groups 302 security alerts 214 into incidents 216 using data 208 about earlier groupings. A machine learning model 206 is trained 902 with select 904, 906 data 208 about past alert-incident grouping actions 210. The trained model 206 help investigators 220 prioritize new alerts 214 and aids alert investigation 1104 by rapidly and accurately grouping 302 alerts 214 with incidents 216 or creating 1140 new incidents 216. The groupings 302, 218 are provided 1144 directly to an analyst 220 or fed 1010 into a security information and event management tool 304. Training data 208 may include entity identifiers 412, alert identifiers 414, incident identifiers 418, action indicators 422, action times 424, and optionally incident classifications 420. Investigative options 318 presented to an analyst 220 but not exercised (e.g., not opened 1138) may serve as training data 208. Incident updates 1008 produced 1136 by the trained model 206 may add 404 an alert 214 to an incident 216, remove 406 an alert 214 from an incident 216, merge 408 two or more incidents 216, divide 410 an incident 216, or create 1140 an incident 216. Personalized incident updates 1008 may be based on a particular analyst's 220 historic manual investigation actions 210. Grouping 302 may be agnostic as to the kind of alert 214, e.g., grouped 302 alerts 214 may be standard alerts, or they may be alerts 214 that are based on custom alert triggering rules 1110.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 9-11 also help describe configured storage media, and help describe the technical effects and operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds or ranges, specific architectures, specific attributes, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A system configured for training a machine learning model to predictively group cybersecurity alerts with cybersecurity incidents based on historic grouping actions, the system comprising:
a digital memory; and
a processor in operable communication with the memory, the processor configured to perform machine learning model training steps, the steps including (a) collecting a set of digital representations of alert-incident grouping actions performed by an analyst, each representation including an entity identifier, an alert identifier, an incident identifier, an action indicator, and an action time, and (b) submitting at least a portion of the set to a machine learning model as training data for training the machine learning model to predict an alert-incident grouping action which is not in the submitted portion of the set.

2. The system of claim 1, wherein the digital representations of alert-incident grouping actions further comprise incident classifications.

3. The system of claim 1, wherein the entity identifiers identify at least four of the following kinds of entity: account, malware, process, file, file hash, registry key, registry value, network connection, IP address, host, host logon session, application, cloud application, domain name, cloud resource, security group, uniform resource locator, mailbox, mailbox cluster, mail message, network entity, cloud entity, computing device, or Internet of Things device.

4. The system of claim 1, wherein the action indicators indicate at least one of the following alert-incident grouping actions by the analyst:
adding an alert to an incident;
removing an alert from an incident;
merging at least two incidents into a single incident; or
dividing an incident into at least two incidents.

5. The system of claim 1, wherein the training data includes a tuple with components that include a current entity identifier, an optional entity identifier, and a chosen entity identifier, and wherein the optional entity identifier identifies an entity presented to the analyst but not chosen by the analyst.

6. The system of claim 1, wherein the action indicator indicates an action was performed by an actor at the action time, and the system is configured to train the machine learning model using at least one of the following training data subsets:
a data subset defined at least in part by a limitation on the action time;
a data subset defined at least in part by a limitation on which actor performed the action;
a data subset defined at least in part by a limitation on which cloud tenant performed or authorized the action;
a data subset defined at least in part by a limitation on which customer performed or authorized the action; or
a data subset defined at least in part by a limitation on which computing environment the action was performed in.

7. A method for training a machine learning model to predictively group cybersecurity alerts with cybersecurity incidents based on historic grouping actions, the method comprising:
collecting a set of digital representations of alert-incident grouping actions, each representation including an entity identifier, an alert identifier, an incident identifier, an incident classification, an action indicator, and an action time; and
submitting at least a portion of the set to a machine learning model as training data for training the machine learning model to predict an alert-incident grouping action which is not in the submitted portion of the set.

8. The method of claim 7, further comprising using the trained machine learning model to predictively group an alert with an incident.

9. The method of claim 8, wherein using the trained machine learning model comprises executing a link prediction algorithm.

10. The method of claim 7, wherein collecting the set of digital representations of alert-incident grouping actions includes collecting data from at least one of the following:
an investigation graph;
an investigation data structure;
a log of investigative actions taken by at least one human user while investigating an alert;
an incident handling data structure; or
a log of incident-handling actions taken by at least one human user while handling an incident.

11. The method of claim 7, wherein collecting includes collecting data from a log of human user activity which grouped alerts with incidents.

12. The method of claim 7, wherein collecting includes collecting data from activity which responded to an alert that is based on a custom rule.

13. The method of claim 7, wherein submitting avoids submitting any of the following alert details data as training data:
an alert provider name;
an alert vendor name;
an alert severity; or
an identification of which rule triggered the alert.

14. The method of claim 7, wherein collecting includes collecting data corresponding to an activity in which an alert was implicitly grouped with an incident.

15. The method of claim 7, further comprising inputting to the trained machine learning model an incident identifier which identifies an incident, and receiving from the trained model an alert identifier which identifies an alert that was not previously grouped with the incident.

16. A computer-readable storage medium configured with data and instructions which upon execution by a processor cause a computing system to perform a method for using a trained machine learning model to predictively group a cybersecurity alert with a cybersecurity incident based on historic grouping actions, the method comprising:
getting an alert;
sending the alert to a trained machine learning model, the model having been trained with training data that includes a set of digital representations of alert-incident grouping actions performed by one or more people as opposed to grouping based on a rules data structure, each representation including an entity identifier, an alert identifier, an incident identifier, an incident classification, an action indicator, and an action time; and
receiving at least one of the following incident updates from the trained model in response to the sending: an alert-incident grouping which groups the alert with an incident, an incident merger which identifies an incident which was created by merging two incidents, or an incident division which identifies at least two incidents which were created by dividing an incident.

17. The storage medium of claim 16, further comprising transmitting the incident update to a security information and event management tool.

18. The storage medium of claim 16, wherein the machine learning model has been trained with training data that includes a set of digital representations of alert-incident grouping actions corresponding to activities in which an alert was explicitly grouped with an incident by a person.

19. The storage medium of claim 16, wherein the computing system performs the method at a performance level of at least twenty-five thousand incident updates per minute.

20. The storage medium of claim 16, wherein the incident update includes a confidence level that is associated with the alert-incident grouping or the incident merger or the incident division which is also part of the incident update.
